(19) United States
(12) Patent Application Publication
(10) Pub. No.: US 2024/0188178 A1
(43) Pub. Date: Jun. 6, 2024

(54) SIDELINK DISCONTINUOUS RECEPTION PROCEDURES

(71) Applicant: KONINKLIJKE PHILIPS N.V., EINDHOVEN (NL)

(72) Inventors: Thomas Fehrenbach, Berlin (DE); Baris Göktepe, Berlin (DE); Sarun Selvanesan, Berlin (DE); Thomas Wirth, Berlin (DE); Thomas Schierl, Berlin (DE); Cornelius Hellge, Berlin (DE)

(21) Appl. No.: 18/284,748

(22) PCT Filed: Mar. 31, 2022
(86) PCT No.: PCT/EP2022/058655

§ 371 Date: Sep. 28, 2023

(30) Foreign Application Priority Data
Apr. 1, 2021 (EP) 21166595.5

(51) Int. Cl. H04W 76/28; H04W 92/18

(52) U.S. Cl. CPC H04W 76/28; H04W 92/18

(57) ABSTRACT

A user device, UE, for a wireless communication system is described. The wireless communication system includes a plurality of user devices, UEs. The UE receives a transmission from one or more further UEs over a sidelink, SL. The UE operates in a Discontinuous Reception, DRX, mode. The UE is to enter an inactive mode or sleep mode if a certain criterion is met.

The present application relates to the field of wireless communication systems or networks, more specifically to a discontinuous reception, DRX, on a sidelink, SL.

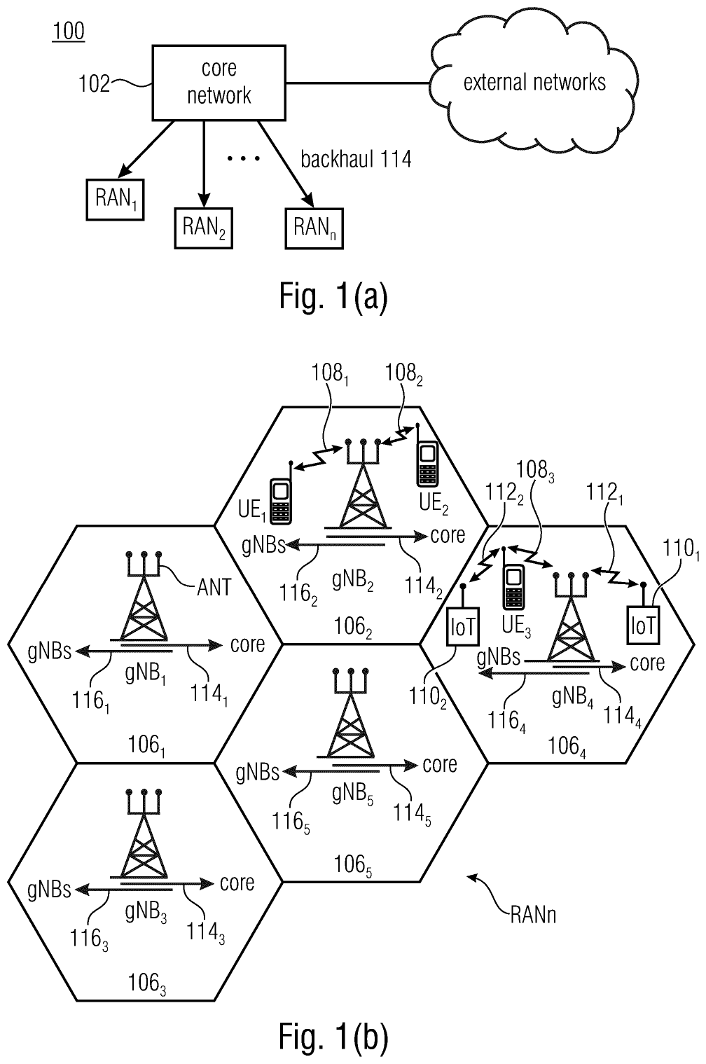

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 1061 to 1065. The base stations are provided to serve users within a cell.

The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 1161 to 1165, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels. When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

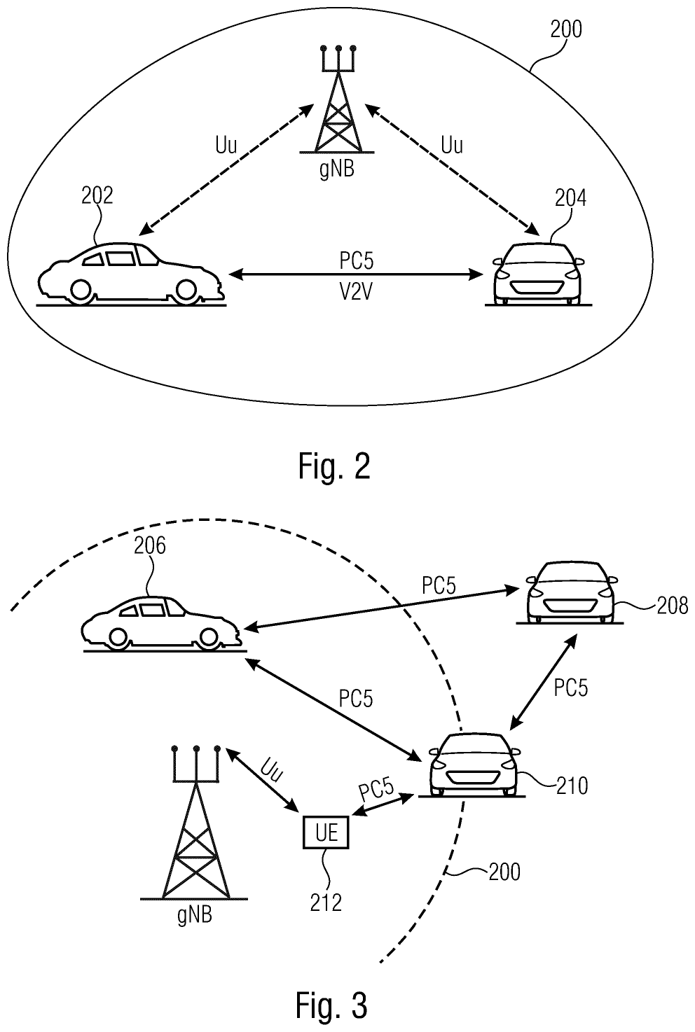

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present. In addition, FIG. 3, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2 and FIG. 3 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In a wireless communication system as described above with reference to FIG. 1, FIG. 2 or FIG. 3, a UE communicating over the sidelink may operate in a discontinuous reception, DRX, mode.

Starting from the prior art as described above, there may be a need for enhancements or improvements for a UE communicating over the sidelink and operating in a discontinuous reception, DRX, mode.

Embodiments of the present invention are now described in further detail with reference to the accompanying drawings:

FIG. 1 shows a schematic representation of an example of a wireless communication system;

FIG. 2 is a schematic representation of an in-coverage scenario in which two UEs directly communicating with each other are both connected to a base station;

FIG. 3 is a schematic representation of an out-of-coverage scenario in which the UEs directly communicate with each other;

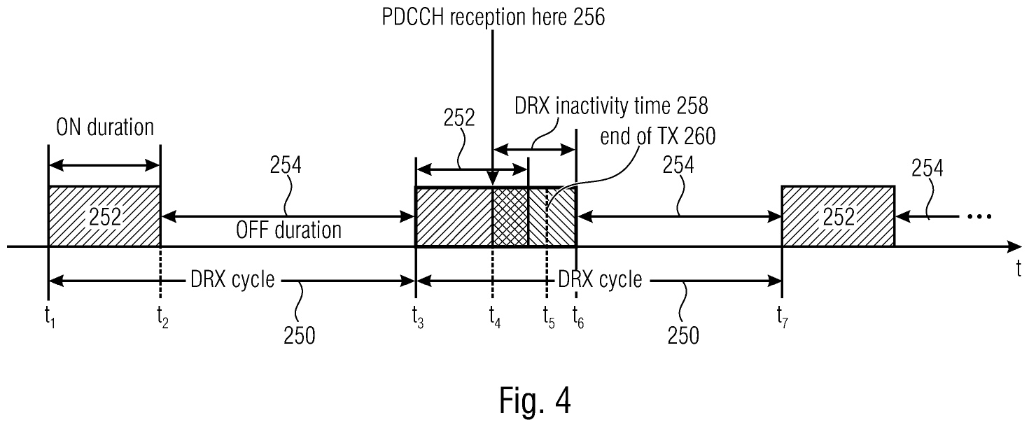

FIG. 4 illustrates a conventional DRX mode at a user device communication with a base station;

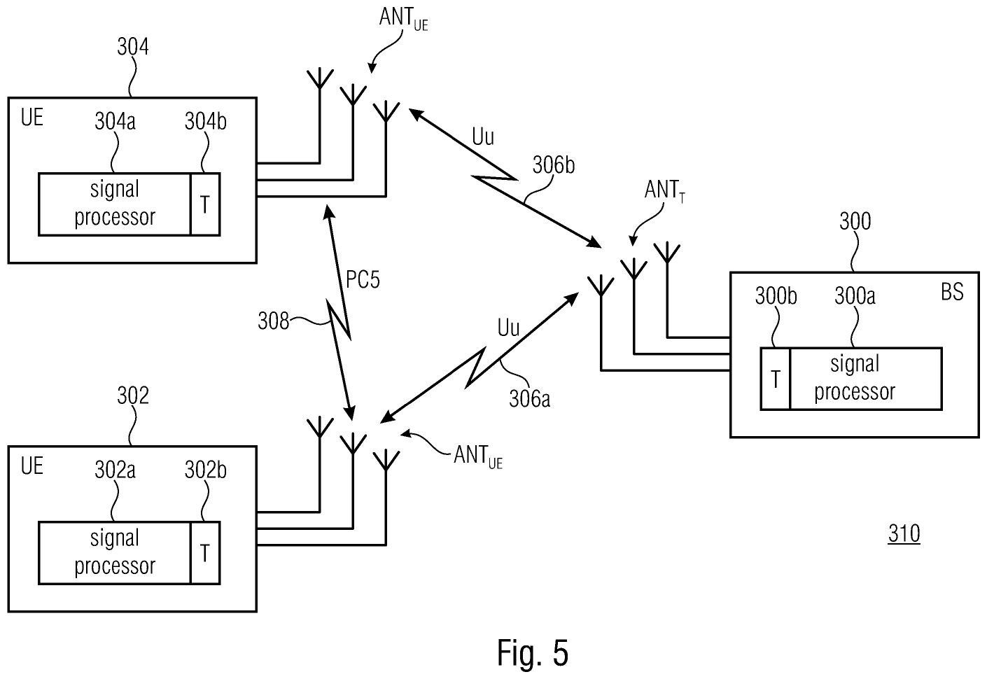

FIG. 5 is a schematic representation of a wireless communication system including a transmitter, like a base station, and one or more receivers, like user devices or UEs, capable of operating in accordance with embodiments of the present invention;

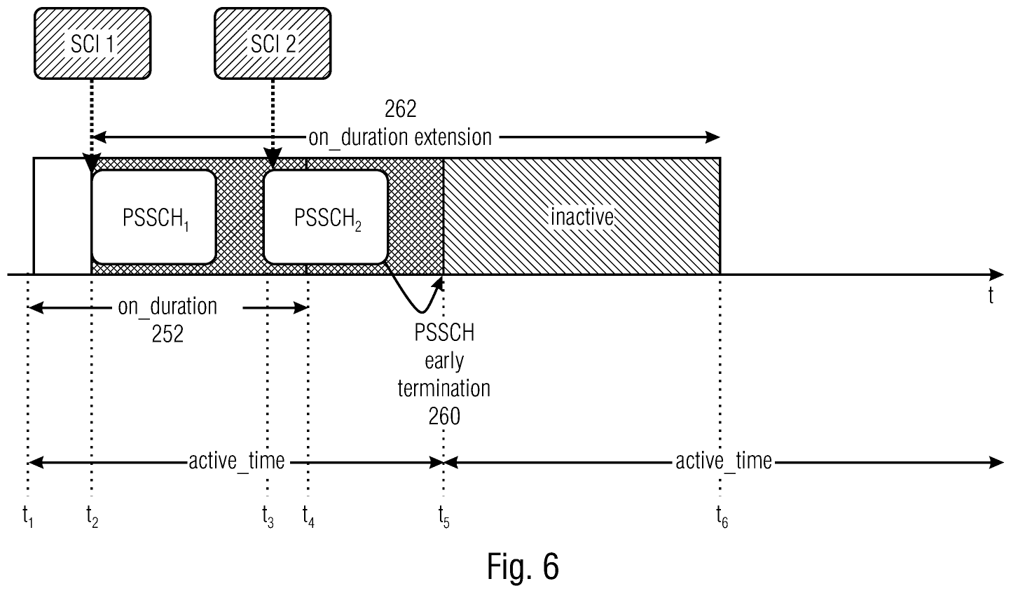

FIG. 6 illustrates an embodiment of an extended ON duration after receiving a control message over the sidelink, like a sidelink control information, SCI, followed by an early termination signaling;

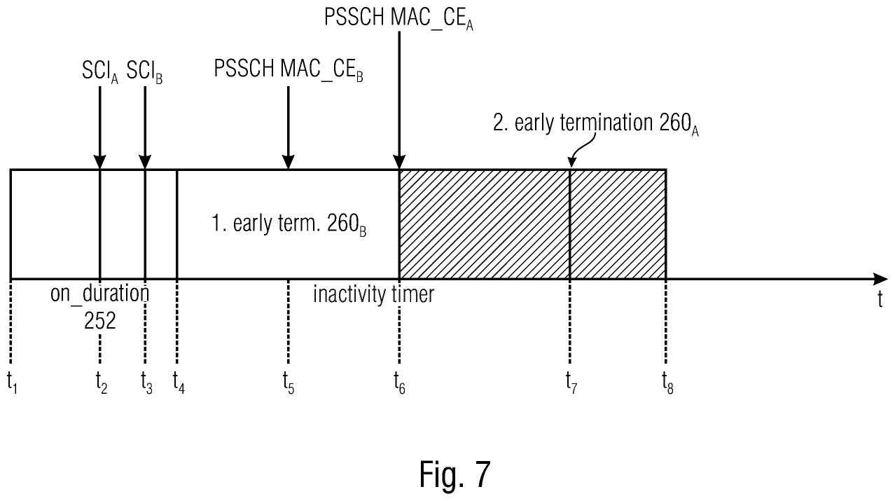

FIG. 7 illustrates an embodiment of an RX UE receives over a sidelink from two TX UEs respective transmissions and an early termination signalings;

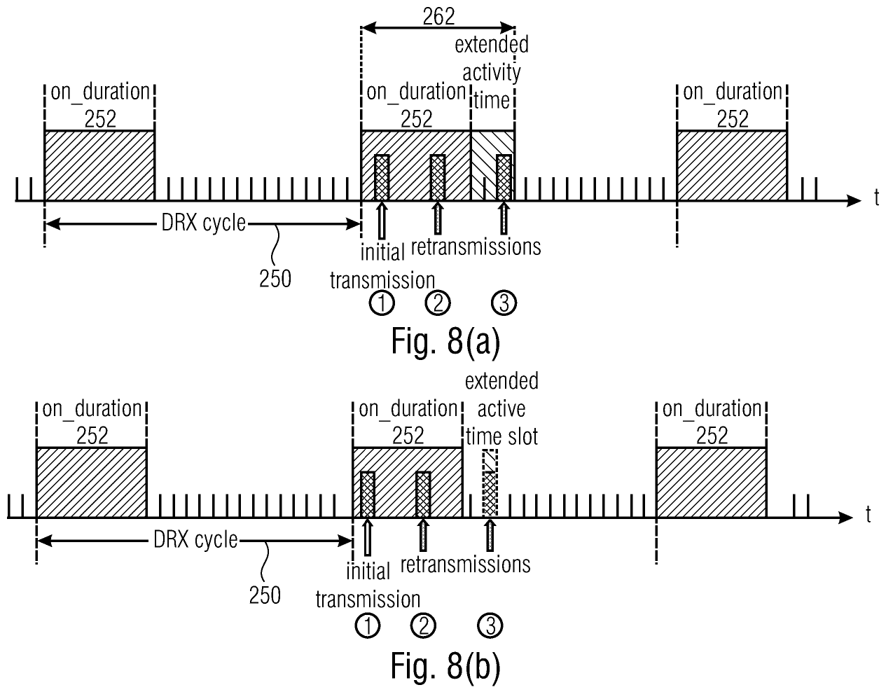

FIG. 8 illustrates embodiments for a power saving by monitoring only indicated resources, wherein FIG. 8(a) illustrates an embodiment of extending an ON duration based on future resource reservations, and FIG. 8(b) illustrates an embodiment of active time slots that are monitored based on the future resource reservations; and

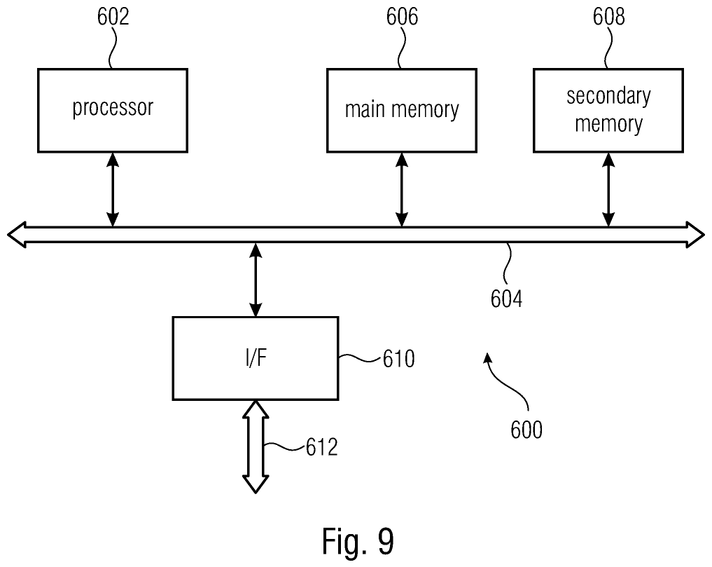

FIG. 9 illustrates an example of a computer system on which units or modules as well as the steps of the methods described in accordance with the inventive approach may execute.

Embodiments of the present invention are now described in more detail with reference to the accompanying drawings in which the same or similar elements have the same reference signs assigned.

In the wireless communication system or network, like the one described above with reference to FIG. 1, FIG. 2 or FIG. 3, a sidelink communication among the respective user devices may be implemented, for example, a vehicle-to-vehicle communication, V2V, a vehicle-to-anything communication, V2X, or any device-to-device communication, D2D, among any other use devices, for example, those mentioned above. However, in a NR-Uu operation or in a sidelink operation, like a PC5 operation, the UE is awake at all times and monitors the control channel in every subframe in order to be able to receive from the network and from another UE, respectively. This increases the power consumption at the UE, since the UE is always on, even when there is no data to be transmitted or received. For vehicular use cases, like NR V2X, power saving may not be a concern since the vehicular UEs, V-UEs, are devices with a sufficient power source, e.g., an onboard battery of the vehicle.

However, the sidelink communication or the sidelink PC5 operation is not limited to the operation of vehicular UEs, but other UEs with a limited or finite power supply, like regular user devices including a battery that needs to be recharged regularly, may communicate over the sidelink. Such UEs may include so-called vulnerable road users, VUEs, like a pedestrian UE, P-UE, or first responder devices for public safety use cases, or IoT devices, like general IoT UEs or industrial IoT UEs. For these types of UEs, since they are not connected to a constant power supply but rely on their battery, power saving is important.

To reduce the power consumption at a UE in NR, the discontinuous reception, DRX, is employed on the Uu interface. For NR, for example, further details of the DRX operation are defined in 3GPP TS 38.321. DRX is a mechanism where the UE goes into a sleep mode for a certain period of time, during which it does not transmit or receive any data. The UE wakes up for another period of time, where it may transmit and receive data. One of the key aspects of DRX is the synchronization between the UE and the network in terms of its wake-up and sleep cycles, also referred to as the DRX cycles. In a worst-case scenario, the network tries to send data to the UE being in the sleep mode so that, when the UE wakes up, there is no data to be received. In the NR-Uu interface this situation is prevented by maintaining a well-defined agreement between the UE and the network or system in terms of the sleep and wake-up cycles. In other words, by configuring a UE with DRX by the gNB, the DRX is synchronized with the gNB. A DRX cycle includes both the ON time and the OFF time within a fixed time interval, and for the NR Uu interface a short DRX cycle and a long DRX cycle is defined, where a short DRX cycle may span a few symbols within a time slot, and a long DRX cycle may span an entire time slot or multiple time slots. An inactivity timer may specify the number of consecutive control messages for which the UE may be active after successfully decoding of a control message that indicates a new transmission, with the following configuration:
the timer is restarted upon receiving a control message for a new transmission and/or any other control message which is addressed to the UE, e.g. scrambled by UE-specific RNTI or group-specific RNTI, or when receiving a corresponding signaling, e.g., from a group leader UE from a base station or from a relay node or from a road side unit, RSU,
upon the expiry of the timer, the UE goes to DRX mode or OFF time.

FIG. 4 illustrates a DRX mode using an inactivity timer. The DRX configuration defines a DRX cycle 250 spanning a certain time and including an on period or ON duration 252 at the beginning of a DRX cycle, followed by an off period or OFF duration 254. On the Uu interface, the UE is awake or active during the ON durations 252. In addition, whenever a transmission or a packet is received during an ON duration, the above-mentioned timer, also referred to as an inactivity timer, is started. In FIG. 4, the reception of a data packet is indicated at 256 during the ON duration 252 of the DRX cycle that starts at time t3. For example, a DCI 256 may be received by the UE on the PDCCH which, in turn, triggers the inactivity timer to be started thereby adding the DRX activity time 258 so that the original ON duration 252 as defined by the DRX configuration is extended from the time t4 to the time t6. This enables a transmitter to send further data associated with the DCI 256 on the PSCCH. In case a transmitter does not intend to send any further data, it may send a DRX command to put the UE into the inactive mode or into the sleep mode. For example, at any time during the inactivity timer duration 258 the UE may receive a DRX command indicating that no further data is to be expected from the transmitter or that the transmitter does not send any further data. Responsive to receiving such an end of transmission signaling 260, for example at a time t5 that is before the end t6 of the inactivity timer duration 258, the UE may return into the sleep mode. It is noted that the end of transmission signaling 260 may also be received for a transmission that does not trigger the inactivity timer so that a regular ON duration 252, as defined by the DRX communication, responsive to the signaling 260 may be terminated before the configured end of the ON duration 252.

The process described above with reference to FIG. 4 for placing a UE operating in the DRX mode into the sleep state or the inactive state responsive to the end of transmission signaling 260 so as to terminate the ON duration 252 before its configured end or to terminate an extended ON duration before the end of the inactivity timer duration 258, works well when the UE is communicating with a base station because the base station is aware about all transmissions for a certain UE, and based on this knowledge, the base station may decide to signal an end of transmission 260 to the UE in case there are no further transmissions for the UEs scheduled. However, the situation is different when considering the sidelink communication.

Over the sidelink, the UE may communicate with several other sidelink UEs which, when activing as transmitters, transmit a unicast message or a groupcast message or a broadcast message, so that the UE may receive from the other sidelink UEs a plurality of transmissions. However, the respective transmitters or TX UEs are not aware of any other ongoing transmissions for the receiving UE or RX UE, so that it is not possible to provide an end of transmission signaling or a sleep command 260 as explained above with reference to FIG. 4, because putting the receiving UE into the sleep mode prohibit the RX UE from receiving data or packets of another ongoing transmission from a different transmitter. For example, the sidelink unicast communication describes a one-to-one communication between two UEs via the sidelink. Therefore, when a transmitter sends the end of transmission or sleep command 260, the receiver may stop listening for further packets from this transmitter. However, as the receiver may have several ongoing transmissions, receiving the end of transmission or sleep command 260 from one transmitter may not be equated to a go to sleep indication as in the case of transmitting over the Uu interface because the receiver may still have to listen for other ongoing transmissions on other links. In case of a sidelink groupcast communication, several UEs within a group may send data, and it not possible to apply the Uu approach described above with reference to FIG. 4 because a UE in the group that transmits or sends data is not aware of other UEs that communicate with the receiving UE. Thus, the UE transmitting the groupcast may not signal to the receiving UE that no further data is expected and that the UE may go to sleep. This is also true for a sidelink broadcast communication in which one transmitter provides a communication to all sidelink UEs, however, also this transmitter is not aware whether the receiving UEs have any other ongoing transmissions on other links so that it may also not send an end of transmission command 260 in a way as described above with reference to FIG. 4 calling a UE to go back into the sleep mode or sleep state.

To reduce the power consumption also at a UE in NR communicating over the sidelink, the DRX mode may also be implemented on the sidelink. A UE communicating over the sidelink may be in-coverage or out-of-coverage, as explained above with reference to FIG. 2 and with reference to FIG. 3. When the UE is in-coverage, even when operating over the sidelink in the DRX mode, the gNB, which is aware of the DRX cycles, handles the resource allocation for transmissions by a UE over the sidelink. This is not possible when the UE is out-of-coverages, e.g., in case the UE operates in Mode 2. Therefore, signaling an end of a transmission by a certain transmitter is not implemented for a UE communicating with other UEs over the sidelink and operating in the DRX mode for placing the UE into the inactive mode or sleep mode.

Thus, the known approach for the Uu interface for placing a UE into the sleep mode as soon as a transmission is terminated, thereby improving the power saving properties, is not available for a sidelink UE so that the power saving possibilities for a sidelink UE operating in a DRX mode may be more limited when compared to a UE communicating over the Uu interface.

Embodiments of the present invention provide enhancements or improvements of the power saving possibilities or capabilities of a UE communicating over the sidelink and operating in a discontinuous reception, DRX, mode. Embodiments of the present invention may be implemented in a wireless communication system as depicted in FIG. 1, FIG. 2 or FIG. 3 including base stations and users, like mobile terminals or IoT devices. FIG. 5 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 5, the one or more UEs 302, 304 of FIG. 5, and the base station 300 of FIG. 5 may operate in accordance with the inventive teachings described herein.

### Apparatus RX UE Enters Sleep Mode/Stops Listening Responsive to Certain Criterion

### SL RX UE

The present invention provides a user device, UE, for a wireless communication system, the wireless communication system including a plurality of user devices, UEs, wherein the UE is to receive a transmission from one or more further UEs over a sidelink, SL, wherein the UE is to operate in a Discontinuous Reception, DRX, mode, and wherein the UE is to enter an inactive mode or sleep mode if a certain criterion is met.

In accordance with embodiments, the certain criterion includes one or more of the following:
reception of an end of transmission signaling,
all transmissions announced from a further UE are received,
successful reception of a transmission with further resources reserved in the future for retransmissions of the said transmission, e.g. an early ACK,
there is no ongoing transmission from another one of the further UEs,
there is no ongoing transmission from a group leader UE or a UE with a certain ID,
there is no ongoing transmission from a base station or relay node,
a content of a received transmission,
a number of times a certain transmission is received, like a transmission including a Cooperative Awareness Message, CAM, or a Decentralized Environmental Notification Message, DENM, or a Basic Safety Message, BSM, transmitted n times, with n=2, 3, 4 . . . .
a battery status of the UE is below a configured or pre-configured threshold,
the UE is moving in a certain geo-location, e.g., a pre-defined zone or inside a building,
the UE is moving or is not moving.

In accordance with embodiments, the user device comprises an inactivity timer specifying an inactivity timer duration during which the UE is to remain in an active state and monitor at least a control channel to detect a transmission, wherein UE is to start the inactivity timer responsive to receiving a transmission by a first further UE.

In accordance with embodiments, the UE is to extend the inactivity timer duration responsive to receiving a further transmission by the first further UE and/or a transmission by a second further UE during the inactivity timer duration or by a signal from a group leader UE or by a signal from a base station or relay node or road side unit, RSU, and wherein the UE is to enter the inactive mode or sleep mode before reaching an end of the extended inactivity timer duration, if the certain criterion is met, e.g., responsive to an end of transmission signaling by both the first further UE and the second further UE.

In accordance with embodiments, the UE is to enter the inactive mode or sleep mode responsive to an end of transmission signaling, and the UE is to receive the end of transmission signaling from one or more of the following:
a further UE performing the transmission that ended,
a further UE not performing the transmission that ended, e.g., a group leader UE of a group of UEs to which the UE belongs,
a relay node,
a road side unit, RSU or an IoT device,
an access point, like a base station, of the wireless communication system.

In accordance with embodiments, an end of transmission signaling by a further UE is indicated by
a signaling of the end of the transmission by the further UE, e.g., using a DRX command Medium Access Control, MAC, Control Element, CE, or
a signaling of a number of resources reserved for the transmission by the further UE, e.g., using a time resource indicator value, TRIV, or a frequency resource indicator value, FRIV, or
a sidelink control information, SCI, e.g., a 1^{st} stage SCI or a 2^{nd} stage SCI, or
an assistance information message, AIM.

### SL TX UE

The present invention provides a user device, UE, for a wireless communication system, the wireless communication system including a plurality of user devices, UEs, wherein the UE is to transmit one or more transmissions to one or more further UEs over a sidelink, SL, the one or more further UEs operating in a Discontinuous Reception, DRX, mode, and wherein the UE is to indicate to the further UE an end of the one or more transmissions so as to enable the further UEs to enter an inactive mode or sleep mode.

In accordance with embodiments, the UE is to indicate an end of the one or more transmissions to a further UE by
a signaling of the end of the transmission to the further UE, e.g., using a DRX command Medium Access Control, MAC, Control Element, CE, or
a signaling of a number of resources reserved for the transmission to the further UE, e.g., using a time resource indicator value, TRIV, or a frequency resource indicator value, FRIV, or
a sidelink control information, SCI, e.g., a 1^{st} stage SCI or a 2^{nd} stage SCI, or
an assistance information message, AIM,
a buffer status report, e.g. indicating how many transmissions or how much data is going to be transmitted to the further UE.

### Restriction of Transmissions to the DRX ON Duration

The present invention provides a user device, UE, for a wireless communication system, the wireless communication system including a plurality of user devices, UEs, wherein the UE is to transmit a plurality of transmissions to one or more further UEs over a sidelink, SL, the one or more further UEs operating in a Discontinuous Reception, DRX, mode, each of the plurality of transmissions comprising at least an initial transmission, and wherein the UE is to transmit the plurality of transmissions to the further UE such that more than at least one of the initial transmissions fall within an ON duration of the DRX cycle of the one or more further UEs.

In accordance with embodiments, one or more of the plurality of transmissions comprises at least one further transmission following the initial transmission at a later time.

In accordance with embodiments, the plurality of transmissions are transmissions associated with a certain criterion.

In accordance with embodiments, the certain criterion comprises one or more of the following:
a priority reaching or exceeding a configured or pre-configured threshold,
a quality of service, QoS, requirement reaching or exceeding a configured or pre-configured threshold,
a packet quota, like a certain configured or pre-configured data rate threshold,
a number of transmissions, like a configured or pre-configured minimum or a maximum number of transmissions, e.g., a CAM or a DENM message,
the content of the messages, e.g., a certain CAM or a certain DENM.

### Configuration of Active Times of a DRX Cycle

### SL RX UE

The present invention provides a user device, UE, for a wireless communication system, the wireless communication system including a plurality of user devices, UEs, wherein the UE is to receive a transmission from one or more further UEs over a sidelink, SL, wherein the UE is to operate in a Discontinuous Reception, DRX, mode, and wherein, during a DRX cycle, the UE is to be active during a certain active time, the certain active time depending on one or more criteria.

In accordance with embodiments, the one or more criteria include one or more of the following:
one or more characteristics of a packet of a transmission,
a logical channel used for a transmission,
a logical channel group used for a transmission,
a quality of service, QoS, flow,
a quality of service, QoS, requirement associated with a transmission, like a priority or delay or data rate,
a geolocation or zone,
a channel busy ratio,
the type of UE,
one or more resources to be used by an initial transmission and/or at least one further transmission,
a current battery status of the UE.

In accordance with embodiments, the UE is to receive a DRX configuration defining the DRX cycle and the active time, and wherein the UE may receive the DRX configuration from one or more of the following:
a further UE performing the transmission,
a further UE not performing the transmission, e.g., a group leader UE of a group of UEs to which the UE belongs,
a relay node,
a road side unit, RSU, or an IoT device,
an access point, like a base station, of the wireless communication system.

### Criteria to Determine Active Times

In accordance with embodiments, the active time is configured or pre-configured or is dynamic.

In accordance with embodiments, the UE is configured or pre-configured with a plurality of ON durations for the DRX cycle, and the UE is to determine an ON duration to be used dependent on the one or more criteria.

In accordance with embodiments, the UE is configured or pre-configured with one or more default ON durations for the DRX cycle, and the UE is to extend a default ON duration to an extended ON duration based on a previous transmission.

In accordance with embodiments, responsive to an end of the transmission that caused the extended ON duration, the UE is to revoke the extension and return to the default ON duration.

### Sparse/Discontinuous Active Times

In accordance with embodiments, a transmission comprises an initial transmission and at least one further transmission following the initial transmission at a later time, and wherein, responsive to an indication of one or more resources reserved for use by the at least one further transmission, the UE is to extend the active time to include at least the indicated one or more resources.

In accordance with embodiments, the UE is to extend the active time by
extending an ON duration for the DRX cycle until the indicated reserved resources, and/or
adding to an ON duration for the DRX cycle only the indicated reserved resources to be monitored during the active time.

In accordance with embodiments, the UE is to enter the inactive or sleep mode between the ON duration and the indicated reserved resources.

In accordance with embodiments, the one or more further transmissions are retransmissions of the initial transmission, and wherein, responsive to successfully receiving the initial transmission within the ON duration, the UE is to enter the inactive or sleep mode, optionally after sending an acknowledgement or a sidelink assistance information (AIM), and is to skip the monitoring of the indicated reserved resources.

In accordance with embodiments, the one or more further transmissions are retransmissions of the initial transmission, and wherein, responsive to not receiving a retransmission at a reserved resource outside the ON duration, the UE is to
stay active for a certain period of time, like an inactivity timer, after a time slot in which the retransmission was expected, or
stay active for reception of n retransmissions, with n≤a signaled or preconfigured maximum number of retransmissions, or
enter the inactive or sleep mode and wake up only during the next ON duration of the DRX cycle, or
send assistance information, e.g., AIM, to the transmitter with time and or frequency information for a retransmission, or
send assistance information, e.g., AIM, to the transmitter with information about an additional ON duration.

In accordance with embodiments, in addition to the reserved resources, the UE is to receive a resource reservation period indicating that the reserved resources are to be used for a further transmission during a period following the reservation period, and wherein, responsive to an indication of the resource reservation period, the UE is to extend the active time to include the indicated one or more resources during a period following the reservation period.

In accordance with embodiments, responsive to a resource reservation period having a certain duration, like zero, which indicates that the transmitter selected other resources for the transmission, the UE is to enter the inactive or sleep mode and wake up only during the next ON duration of the DRX cycle.

In accordance with embodiments, the one or more resources to be used by the at least one further transmission are indicated in a control message, like a sidelink information, SCI, message, received by the UE.

In accordance with embodiments, the SCI indicates the resources reserved within a certain number of future time slots using, e.g., a time resource indicator value, TRIV, format or a frequency resource indicator value, FRIV, format, and, optionally, the resource reservation period indicating that the reserved resources are to be used for a further transmission during a period following the reservation period.

### SL TX UE

The present invention provides a user device, UE, for a wireless communication system, the wireless communication system including a plurality of user devices, UEs, wherein the UE is to communicate with one or more further UEs over a sidelink, SL, wherein the UE is to configure one or more of the further UEs to operate in a Discontinuous Reception, DRX, mode, and wherein the UE is to determine a DRX configuration for a further UE dependent on one or more criteria.

In accordance with embodiments, the one or more criteria include one or more of the following:
one or more characteristics of a packet of a transmission,
a logical channel used for a transmission,
a logical channel group used for a transmission,
a quality of service, QoS, flow,
a quality of service, Qos, requirement associated with a transmission, like a priority or delay or data rate,
a geolocation or zone,
the type of the other UE,
one or more resources to be used by an initial transmission and/or at least one further transmission,
a current battery status of the UE.

### Extension/Restriction of Active Times

The present invention provides a user device, UE, for a wireless communication system, the wireless communication system including a plurality of user devices, UEs, wherein the UE is to receive a transmission from one or more further UEs over a sidelink, SL, wherein the UE is to operate in a Discontinuous Reception, DRX, mode, and, during a DRX cycle, is to be active during a certain active time, like the ON duration, and wherein the UE is to decode or skip decoding a transmission responsive to one or more criteria.

In accordance with embodiments, the one or more criteria comprise a priority and/or a destination and/or a Hybrid Automatic Repeat Request, HARQ, indicator associated with the transmission and/or a cast type associated with the transmission, like a unicast transmission or a groupcast transmission or a broadcast transmission.

In accordance with embodiments, in case a HARQ indicator associated with the transmission indicates that the transmitter requests a feedback for the transmission, the UE is to decode the transmission and send the feedback.

In accordance with embodiments, the UE is to check a priority field in a 1^{st} stage SCI on a physical sidelink control channel, PSCCH, and is to skip decoding of an associated physical sidelink shared channel, PSSCH, if the priority field indicates a priority that is below a certain priority threshold.

In accordance with embodiments, the UE is to check a destination field in a 2^{nd} stage SCI on a physical sidelink shared channel, PSSCH, and skip further decoding of the PSSCH if the destination field indicates that the transmission is not addressed to the UE or to a group of UEs to which the UE belongs.

In accordance with embodiments, the UE it to check the cast type in a SCI, like a 1^{st} stage SCI or a 2^{nd} stage SCI, and is to skip further decoding of the PSSCH if the transmission is of a certain cast type.

In accordance with embodiments, the UE is to check a source ID field in a 2^{nd} stage SCI on a physical sidelink shared channel, PSSCH, and is to skip further decoding of the PSSCH if the source ID field indicates that the transmission is not from a transmitter the UE is intending to receive communications from or is not on a list of source IDs to decode.

In accordance with embodiments,
if decoding of a 2^{nd} stage SCI fails and a priority field of a 1^{st} stage SCI indicates a priority at or above the certain threshold, the UE is to be active to receive a retransmission, e.g., by extending an active time until the retransmission is received, or is to become active at resources indicated or reserved in the 1^{st} stage SCI for the retransmission, or
if decoding of the 2^{nd} stage SCI fails and the transmission is at a resource location previously reserved by a transmission for the UE, the UE is to extend an active time until the retransmission or another transmission is received, or
if a previously reserved resource does not contain an expected transmission, the UE is to extend an active time until the retransmission or another transmission is received.

### Actions Based on Feedback

The present invention provides a user device, UE, for a wireless communication system, the wireless communication system including a plurality of user devices, UEs, wherein the UE is to communicate with one or more further UEs over a sidelink, SL, the one or more further UEs operating in a Discontinuous Reception, DRX, mode, wherein the UE is to transmit one or more HARQ enabled transmissions to a further UE during an ON duration of a DRX cycle of the further UE, and wherein, responsive to not receiving a HARQ feedback, the UE is to hold back the HARQ enabled transmission until the next ON duration of the further UE and to transmit the HARQ enabled transmission during the next ON duration of the further UE.

In accordance with embodiments, holding back the HARQ enabled transmission comprises one of more of the following:
no further retransmission for a current transport block, TB,
no further retransmissions until the next ON duration
restarting a retransmission counter during the next ON duration,
using an initial redundancy version, RV,
reduce a number of retransmissions dependent on an amount of ON durations experienced.

In accordance with embodiments, the UE is to retransmit the HARQ enabled transmission for a certain number of times, although a default ON duration has passed, and, responsive to not receiving a HARQ feedback, the UE is to hold back the HARQ enabled transmission until the next ON duration of the further UE and to transmit the HARQ enabled transmission during the next ON duration of the further UE.

### System

The present invention provides a wireless communication system, comprising a plurality of the inventive user devices, UEs, configured for a sidelink communication using, for example resources from a set of sidelink resources of the wireless communication system.

### Method

### RX UE Enters Sleep Mode/Stops Listening Responsive to Certain Criterion

### SL RX UE

The present invention provides a method for operating a user device, UE, for a wireless communication system, the wireless communication system including a plurality of user devices, UEs, wherein the UE is to receive a transmission from one or more further UEs over a sidelink, SL, and wherein the UE is to operate in a Discontinuous Reception, DRX, mode, the method comprising: entering an inactive mode or sleep mode if a certain criterion is met.

### SL TX UE

The present invention provides a method for operating a user device, UE, for a wireless communication system, the wireless communication system including a plurality of user devices, UEs, the method comprising: transmitting one or more transmissions to one or more further UEs over a sidelink, SL, the one or more further UEs operating in a Discontinuous Reception, DRX, mode, and indicating to the further UE an end of the one or more transmissions so as to enable the further UEs to enter an inactive mode or sleep mode.

### Restriction of Transmissions to the DRX ON Duration

The present invention provides a method for operating a user device, UE, for a wireless communication system, the wireless communication system including a plurality of user devices, UEs, the method comprising: transmitting a plurality of transmissions to one or more further UEs over a sidelink, SL, the one or more further UEs operating in a Discontinuous Reception, DRX, mode, each of the plurality of transmissions comprising at least an initial transmission, wherein the plurality of transmissions are transmitted to the further UE such that more than at least one of the initial transmissions fall within an ON duration of the DRX cycle of the one or more further UEs.

### Configuration of Active Times of a DRX Cycle

### SL RX UE

The present invention provides a method for operating a user device, UE, for a wireless communication system, the wireless communication system including a plurality of user devices, UEs, wherein the UE is to receive a transmission from one or more further UEs over a sidelink, SL, and wherein the UE is to operate in a Discontinuous Reception, DRX, mode, the method comprising: during a DRX cycle, staying active during a certain active time, the certain active time depending on one or more criteria.

### SL TX UE

The present invention provides a method for operating a user device, UE, for a wireless communication system, the wireless communication system including a plurality of user devices, UEs, wherein the UE is to communicate with one or more further UEs over a sidelink, SL, the method comprising: configuring one or more of the further UEs to operate in a Discontinuous Reception, DRX, mode, wherein a DRX configuration for a further UE is determined dependent on one or more criteria.

### Extension/Restriction of Active Times

The present invention provides a method for operating a user device, UE, for a wireless communication system, the wireless communication system including a plurality of user devices, UEs, wherein the UE is to receive a transmission from one or more further UEs over a sidelink, SL, and wherein the UE is to operate in a Discontinuous Reception, DRX, mode, and, during a DRX cycle, is to be active during a certain active time, like the ON duration, the method comprising: decoding or skipping decoding a transmission responsive to one or more criteria.

### Actions Based on Feedback

The present invention provides a method for operating a user device, UE, for a wireless communication system, the wireless communication system including a plurality of user devices, UEs, wherein the UE is to communicate with one or more further UEs over a sidelink, SL, the one or more further UEs operating in a Discontinuous Reception, DRX, mode, the method comprising: transmitting one or more HARQ enabled transmissions to a further UE during an ON duration of a DRX cycle of the further UE, and responsive to not receiving a HARQ feedback, holding back the HARQ enabled transmission until the next ON duration of the further UE and transmitting the HARQ enabled transmission during the next ON duration of the further UE.

### Computer Program Product

Embodiments of the present invention provide a computer program product comprising instructions which, when the program is executed by a computer, causes the computer to carry out one or more methods in accordance with the present invention.

### Implementing Early Termination for a SL Communication

Embodiments of a first aspect of the present invention provide approaches for improving the power saving possibilities or capabilities of a receiver, like a sidelink UE, communicating with other UEs over the sidelink, by allowing the UE to enter an inactive mode or sleep mode if a certain criterion is met. Stated differently, embodiments of the present invention provide for the implementation of an early termination of an active time of a DRX cycle also for a communication over the sidelink.

In accordance with embodiments, a SL RX UE may enter an inactive mode or sleep mode in case one or more of the following criteria is met:
The reception of an end of transmission signaling.
All the transmissions that have been announced from a further UE are received. For example, the further UE may transmit a Buffer Status Report, BSR-like report to the RX UE announcing that it is going to transmit a certain amount of data. Once the RX UE has received that amount it assumes or expects no further data transmissions to come from this UE.
The successful reception of a transmission with further resources reserved in the future for one or more retransmissions of the said transmission, e.g. an early ACK, There is no ongoing transmission from another one of the further UEs on the SL.
There is no ongoing transmission from a group leader UE or a UE with a certain ID.
There is no ongoing transmission from a base station or a relay node.
The reception of an end of transmission signaling and no ongoing transmission from another one of the further UEs on the SL.
A content of a received transmission, for example transmissions including certain messages, like a Cooperative Awareness Message, CAM, a message in the 5.9 GHz intelligent transport system, ITS-G5, or a Decentralized Environmental Notification Message, DENM, or a Basic Safety Message, BSM.
A number of times a certain transmission is received.
For example, after receiving the same transmission multiple times, like 2 times, 3 times or, more generally, n times, with n being a configured or preconfigured natural number N greater than 1, the UE may decide that it need no further transmission and may go into the sleep mode until the next ON duration. For example, this may be applied for transmission including a Cooperative Awareness Message, CAM, or a Decentralized Environmental Notification Message, DENM, or a Basic Safety Message, BSM, so that when receiving the same message multiple times on different transmissions, the UE may decide that it doesn't need it more often.
The battery status of the SL RX UE is below a configured or pre-configured threshold.
The SL RX UE is moving in a certain geo-location, e.g., a pre-defined zone or inside a building.
The SL RX UE is moving or not moving.
For example, whether the UE is moving or nor may be determined based on its GPS position or on a variance in the channel impulse response. In case the UE does not move, a frequency flat channel is given and there is substantially no change in the channel impulse response.

Thus, by allowing the SL receiver to sleep or stop listening, the power preserving capabilities over the sidelink communication are improved by reducing an active time, as is also possible when communicating over the Uu interface.

Embodiments of a first aspect of the present invention are now described with reference to scenarios in which a SL RX UE decides about entering the sleep or inactive mode responsive to receiving an end of transmission signaling from the sidelink transmitting UE, SL TX UE, i.e., from the UE that sends the transmission. A sidelink receiver, SL RX UE, may decide about an early termination of an ON duration when operating in the DRX mode, responsive to a transmitter, SL TX UE providing a signaling that indicates if and/or where to expect one or more further transmissions following an initial transmission.

FIG. 6 illustrates an embodiment of an extended ON duration after receiving a control message over the sidelink, like a sidelink control information, SCI, followed by an early termination signaling. SL TX UE, transmits an initial SCI1 during an ON duration 252 of a SL RX UE. The ON duration starts at a time t1, and during the ON duration 252, at a time t2, SCI1 is received which is followed by a first data transmission PSSCH1 from the TX UE to the RX UE over the sidelink. When receiving SCI1, the ON duration 252 is extended beyond the original duration that ends at t4. During the original ON duration 252 or during the extended ON duration, the TX UE may send a further transmission associated with SCI2 that is received at a time t3 which, in the depicted embodiment, is before the end of the original ON duration 252 at t3. Since the ON duration 252 has been extended, the RX UE remains active for an extended duration and also receives the further data transmission PSSCH2. Further, responsive to receiving SCI2, the ON duration is further extended, for example by restarting the inactivity timer, so that in the embodiment depicted in FIG. 6, the overall ON duration extension 262 extends the original ON duration 252 from time t4 to time t6.

In accordance with embodiments, to allow a RX UE communicating with the TX UE over the sidelink to improve its power saving properties, the TX UE includes into the transmission an indication to the RX UE that the UE is not to expect further transmissions from the TX UE. The TX UE may indicate to the RX UE a PSSCH early termination 260. For example, at the end of the last data transmission PSSCH2 the end of the transmission from the TX UE may be signaled by transmitting at the end of the PSSCH2 the PSSCH early termination 260 thereby informing the RX UE that it is not to expect any further transmissions from the TX UE. The RX UE may terminate the extended ON duration 262 at a time t5, i.e., following the time t5 the RX UE may go into an inactive state. Thus, in accordance with embodiments, by allowing a sidelink TX UE to signal to the sidelink RX UE the end of a transmission, the sidelink RX UE is capable of terminating the extended ON duration 262, i.e., the RX UE may go in to the inactive state as it is no longer needed to monitor for further transmissions which are indicated no to occur. This allows the RX UE to preserve power by the reduction of the active time to the time period between t1 and t5, instead of the time period between t1 and t6.

With regard to the embodiment of FIG. 6, it is noted that the termination 260 of a transmission may also occur in the situation in which a transmission from a TX UE only occurs during the ON duration 252. For example, the transmission PSSCH1 may include the early termination 260, for example at the end of the transmission, so that the RX UE, responsive to the termination signaling may enter into the inactive state after receiving PSSCH1 so that the original ON duration 252 may be terminated ahead of the original end at a time t4. For example, the termination may be at a time t3 following an early termination indication from the TX UE. In this situation, the active time may be limited to the period between t1 and t3 also allowing for preserving power by reducing the active time.

During the active time the RX UE monitors at least a control channel to detect further transmissions, like the second transmission indicated by SCI2 in FIG. 6. In case no termination 260 is received, the RX UE continues to monitor the time period from the end of PSSCH2 to t6, the end of the extended ON duration 262. In case a further transmission is detected, for example by detecting a further SCI, the ON duration 262 may be further extended, for example, by restarting the inactivity timer. However, as mentioned above, in the example of FIG. 6, without the termination 260, the RX UE further monitors at least the control channel until the time t6, thereby wasting power which may be preserved by allowing the RX UE to terminate the extended ON duration 262 or the ON duration 252, responsive to the signaling that the RX UE is not to expect further transmissions from the TX UE. Thus, during the active times, the TX UE may transmit one or more transmissions to the receiver or RX UE which triggers the extension of the active time so that the transmitter may follow up with further transmissions during the extended active time. When the transmitter completed its transmissions, the receiver no longer listens until the end of the dynamically extended active time 262 because responsive to the signal 260, the RX UE is allowed to stop listening for transmissions from the transmitter that indicated the end of a transmission.

In accordance with embodiments, the signaling 260 provided by the TX UE to the RX UE may be an end of transmission indication, for example by delivering a MAC control element, CE, like a DRX command explicitly indicating at an end of a transmission that no further transmission from the TX UE is to be expected, as is illustrated in the embodiment of FIG. 6.

In accordance with embodiments, rather than signaling an end of transmission indication as illustrated in FIG. 6, the TX UE, upon providing the control information, may indicate that there are further transmissions. In accordance with an embodiment, the TX UE may send a buffer status report, e.g., indicating how many transmissions or how much data is going to be transmitted to the RX UE. In accordance with another embodiment, the TX UE, upon providing the control information, may indicate the resources reserved for the transmissions. For example, when considering the TX UE to be operating in mode 2, the resources reserved for the transmissions may be signaled. Thus, instead of indicating or signaling and end of a transmission, the control message associated with a certain transmission, like the SCI, and/or an assistance information message, AIM, may indicate a certain number of resources that are reserved for the transmission indicated in the control message, for example in the form of the actual resources that are reserved. This may be applied, for example, in case of performing one or more transport block, TB, retransmissions but also for further transmissions.

For example, when considering an operation in mode 2, as described above with reference to FIG. 3, the TX UE may have slightly different methods of operation for periodic or semi-persistent transmissions/retransmissions and aperiodic or dynamic transmissions/retransmissions. For example, a number N of maximum transmissions/retransmissions may be limited to 32 for periodic and aperiodic transmissions. One restriction on this number may be the number of available resources in a candidate resource set while another restriction may be the number of resources that may be indicated in an SCI which may only be three resources at a maximum, including the resource in which an initial or first transmission occurs. These resources may be restricted to be within a 32 ms window.

In mode 2, the UE identifies the resources required for each of the possible transmissions/retransmissions from within the resources available in the candidate resource set, and there may be a restriction based on the packet delay budget, PDB, of the TB. Once a UE identifies a list of available candidate resources, the UE selects the N candidate resources. The UE initially selects randomly one of the N candidate resources. When considering that the first candidate resource selected at a slot m1, the UE then selects also randomly the second candidate resource, but with the restriction that a gap between this candidate resource and the first selected candidate resource needs to be smaller than a window W of 32 slots. This means that the second candidate resource may be located at a slot m2 within the range of slots [m1−31, m1+31]. This guarantees that a first stage SCI of one of the two selected candidate resources is able to reserve the other candidate resource. If N>2, the UE selects also randomly the third candidate resource but with the restriction that it is located at the slot m3 within the range [m1−31, m1+31] or within the range [m2−31 to m2+31]. This chain procedure is repeated with the aim that all candidate resources for the transmissions/retransmissions are reserved by a previous SCI. However, if the UE may only select the subset of N candidate resources following this procedure, the remaining resources are selected randomly within the selection window even if they do not meet the previous first stage limitations.

For transmitting TBs of different sizes, the number of subchannels used for the transmission may be varied, and the number of subchannels is selected such that the TB and its associated SCI, including the first and second stage SCIs, fits into the candidate resource set. This may be restricted by a maximum number of subchannels defined or allowable in a resource pool defining resources to be used for the sidelink communication.

Only the UE transmitting a TB is aware of the PDB associated with the TB, and dependent on the PDB, the selection window may be selected, and all transmissions/retransmissions associated with the TB need to be completed within the selection window. For aperiodic transmissions, a reselection counter may keep track of a number of transmissions/retransmissions, and the reselection counter may be decremented by one after finishing the transmission of a TB, i.e., after transmitting the TB and all its possible retransmissions. Before transmitting the last TB that sets the reselection counter to zero, the TX UE may evaluate whether new resources are to be selected for a next TB. If this is the case, the UE may set a resource reservation period to Oms in the first stage SCI thereby indicating to other UEs that it is not reserving the same resources for the next TB. Otherwise, the UE may keep the same resources already reserved for the next TB, and the same resource reservation period is including the in the first stage SCI.

In the above-described examples of determining the resources for a plurality of transmissions including, for example, an initial transition and one or more retransmissions thereof, a transmitter may signal to a receiving UE the reserved resources for a certain transmission, so that the UE receiving, for example, the SCI or the AIM, is aware when a certain transmission ends. The resources may be indicated for example, in the following ways. For example, the resources across time may be indicated in any one of the following manners:
by a bitmap across time, the bitmap indicating resources, like OFDM symbols or time slots or subframes or frames, where the resource set is defined, spanning either a portion or the entire length of the one BWP,
by a starting resource, like a time slot or a subframe, and a duration of the resource set,
by explicit resources numbers, like time slot or subframe numbers,
by puncturing out resources mentioned explicitly or that are part of another set of resources or RP,
by a starting resource, and periodic offsets for subsequent occurrences,
by a pattern of symbols, time slots or subframes or frames,
by a formula used to define the time resource indicator value, TRIV defined in TS38.214 as follows:

```
if N = 1
    TRIV = 0
  elseif N = 2
    TRIV = t₁
  else
    if (t₂ − t₁ − 1) ≤ 15
      TRIV = 30 (t₂ − t₁ − 1) + t₁ + 31
    else
      TRIV = 30 (31 − t₂ + t₁) + 62 − t₁
    end if
  end if
```

where,
N indicates the number of time slots indicated by the AIM, where
   0 means the time slot where the AIM was received,
   1 means the time slot where the AIM was received as well as one more future time slot with respect to the time slot the AIM was received,
   2 means the time slot where the AIM was received as well as two more future time slots with respect to the time slot the AIM was received,
t₁ indicates the first future resource time slot with respect to the time slot the AIM was received, and
t₂ indicates the second future resource time slot with respect to the time slot the AIM was received.

The resources across frequency may be indicated in any one of the following manners:
by a bitmap, the bitmap indicating resources, like resource blocks, across the one BWP,
by a starting resource, like a resource block, and a number of resources for a resource set,
by multiple starting resources, like resource blocks, and ending resources, if the resource set is non-contiguous over frequency,
by explicit resource indices, like resource block indices,
by puncturing out resources mentioned explicitly or that are part of another set of resources or RP,
by a starting resource, and periodic offsets for subsequent occurrences,
by a pattern of resource blocks or subchannels,
by a formula used to define the frequency resource indicator value, FRIV, defined in TS38.214 as follows:

FRIV=_{nsubCH,1}^{start}+Σᵢ₌₁^{L}^{_{subCH}}⁻¹(N_{subchannel}^{SL}+1−i).

The resources across time and frequency may be indicated in any one of the following manners:
by a matrix, the matrix indicating the resources across time, like symbols, time slots or subframes or frames, and across frequency, like resource blocks or subchannels,
by a pattern, the pattern indicating the resources across time, like symbols, time slots or subframes or frames, and across frequency, like resource blocks or subchannels. The pattern may be signaled as a bitmap or bit vector.

Thus, by means of the above formats, the resources reserved for the transmissions by the TX UE may be signaled, for example, in SCI1 of FIG. 6. Upon receiving an indication of the reserved resources, the RX UE may determine a time at which no further transmissions are to be expected from the TX UE. The SCI1 may include assistance information or the RX UE may receive an additional assistance information message, AIM, informing the RX UE about the resources reserved for the transmissions from the TX UE so that the RX UE is aware that following the transmission PSSCH2 it is not to expect any further transmissions from the TX UE and therefore may go into the inactive state at 15. Likewise, when SCI1 only indicates the resources for PSSCH1, the RX UE does not expect from the TX UE further transmissions after PSSCH1 and therefore may enter into the inactive state at t3.

In accordance with further embodiments, the RX UE, when receiving an indication that a transmission by one TX UE terminates, may enter into the inactive state as explained above, if there is only a single ongoing transmission from a single TX UE over the sidelink to the RX UE. However, the RX UE may also communicate with one or more further sidelink TX UEs and may receive from another TX UE transmissions. Therefore, in accordance with embodiments, the RX UE communicating with a plurality of TX UEs over the sidelink may enter into an inactive state responsive to the signaling of an early termination 260 of a transmission from one TX UE only once the RX UE checked that there is no further ongoing transmission with another TX UE. Stated differently, responsive to an indication of an end of a transmission from one TX UE, the RX UE may go into the sleep mode or into the inactive state, if it is not active due to a transmission from another TX UE.

FIG. 7 illustrates an embodiment of the present invention in accordance with which an RX UE receives from a first TX UE A and from a second TX UE B transmissions over a sidelink. During an ON duration 252 that extends from t1 to t4, the RX UE receives a SCI_{A} associated with one or more transmissions from a TX UE A over the sidelink. Receiving the SCI_{A} causes an extended ON duration 252 from the time t4 to the time t7. At a time t3, RX UE receives a further SCIs associated with one or more transmissions by a further TX UE B which, in turn, causes a further extension of the ON duration or active time from time t7 to time t8. In accordance with the embodiment depicted in FIG. 7, the TX UE B may signal the PSSCH MAC_CE_{B} indicating that the RX UE is not to expect any further transmissions from TX UE B. This may be received at a time t5 so that, responsive to this signaling, the RX UE is capable to enter into the inactive mode, i.e., it is capable to terminate the extended ON duration. However, the RX UE did not yet receive any indication from TX UE A that it is not to expect any further transmissions from TX UE A so that, in accordance with embodiments of the present invention, due to the ongoing transmission by TX UE A, the RX UE, at t5, responsive to the first early termination 260A does not take any action, i.e., remains in the active state and keeps monitoring the control channel for further transmissions. At time t6, TX UE A sends PSSCH MAC_CE_{A} indicting that no further transmissions are to be expected from TX UE A so that the RX UE may initiate the early termination 260A at the time t7 and enter into the inactive mode before the actual end of the extended ON duration at time t8 so as to allow preserving power. At the time t6, the RX UE is aware that the only ongoing transmission is the one from TX UE A as all other transmissions, like the one from TX UE B already terminated, as was signaled by the TX UE B so that responsive to the early termination signaled by the TX UE A, the RX UE, at time t7, may go into the sleep or inactive mode.

Thus, by providing by the TX UEs the indication that no further transmissions are to be expected from the respective TX UE, a receiver may reliably detect when it may actually go into the sleep or inactive mode or stop listening to control channels for further transmissions, which allows reducing the power consumption as the RX UE needs not to be active over the entire extended ON duration period as explained above with reference to FIG. 6 and FIG. 7.

The present invention is not limited to the above embodiments in which the end of transmission signaling. is provided by the SL TX UE that transmits the transmission. Rather, in accordance with other embodiments, the end of transmission signaling may be provided by one or more the following entities of the wireless communication network:
A further UE not performing the transmission that ended, e.g., a group leader UE of a group of UEs to which the UE belongs.
A relay node.
A road side unit, RSU.
An IoT device.
An access point, like a base station, of the wireless communication system, for example, when the SL TX UE is a Mode 1 UE.

### Restriction of Transmissions to the ON Duration by TX UE

Embodiments of a second aspect of the present invention provide an approach which allows an RX UE communicating with a transmitter over the sidelink to preserve power by avoiding unused ON duration s. More specifically, when considering a situation as the one depicted in FIG. 6, in case a TX UE sends a transmission at an arbitrary time, for example outside the ON duration 252 of the RX UE, a transmission by the TX UE is not received and the TX UE may send retransmissions, if configured to do so, which, eventually, may be detected by the RX UE in the next ON duration. However, this caused the RX UE to initially monitor an ON duration during which no transmission occurred so that during this time, power may not be preserved.

In accordance with embodiment of the second aspect, such a situation is avoided and, thereby power may be preserved, by making sure that the RX UE receives the start of a transmission during the ON duration 252 (see FIG. 6). Thus, embodiments of the present invention provide a TX UE that starts its transmission during the time when the RX UE is active, i.e., during the ON duration. The transmission operation may be performed in the MAC scheduler and the PHY layer reports a set of candidate resources to the MAC scheduler, as also described above. When deciding which candidate resources to use for a transmission or data packet or when deciding which data packet to transmit next, the MAC scheduler takes into consideration the corresponding one or more ON durations of the DRX cycle employed by the RX UE as well as possible extensions obtained by the inactivity timer.

In accordance with embodiments, this approach may be applied for transmissions associated with the priority having a certain configured or pre-configured threshold or level, also referred to as high priority transmissions. To increase the reliability of such high priority transmissions, the RX UE is to detect the transmission reliably. In case the RX UE does not receive the high priority transmission during an ON duration, the RX UE enters into the sleep mode or inactive mode. To make sure that such a transmission is detected and, if needed, further active times are obtained by extending the ON duration for potential retransmissions, the TX UE places an initial transmission to be within the ON duration of the RX UE, thereby making it less likely that the RX UE misses all of the transmitter's transmissions. Thus, while making sure that the transmissions are received at the RX UE, also it is ensured that they are received in an initial ON duration, thereby avoiding a waste of power when not sending the initial transmission during an ON duration but only a retransmission.

In accordance with further embodiments of the second aspect, this approach may be applied also
for transmissions with a quality of service, QoS, requirement reaching or exceeding a configured or pre-configured threshold, or
for transmissions with a certain packet quota, like a certain configured or pre-configured data rate threshold, or
dependent on a configured or pre-configured number of transmissions, like a minimum or a maximum number of transmissions, e.g., a CAM or a DENM or a BSM,
the content of the messages, e.g., a certain CAM or a certain DENM.

### Configuration of Active Times by the TX UE

In the embodiments described above, the active times are defined either by the ON duration 252 or by the extended ON duration 262. In accordance with embodiments of a third aspect of the present invention, the active times may be determined dependent on one or more of the following:
the properties or characteristics of a data packet to be sent, e.g., one or more characteristics of a packet of a transmission,
the destination RX UE, like the type of the UE,
a logical channel used for a transmission,
a quality of service, QoS, flow,
a quality of service, QoS, requirement associated with a transmission, like priority, or delay or data rate,
a logical channel group used for a transmission,
a battery status of the UE
the UE is moving in a certain geo-location, e.g., a pre-defined zone or inside a building,
a channel busy ratio,
the type of UE,
one or more resources to be used by an initial transmission and/or at least one further transmission.

Thus, dependent on one or more of the above criteria, the active time of a DRX cycle may vary. For example, the RX UE may be configured or preconfigured with a plurality of different ON durations 252, which may be periodic, and a TX UE may be aware of the configured/preconfigured ON durations available at the RX UE, so that, depending on a service or a communication link, the TX UE may indicate together with the control information associated with a transmission the active time or ON duration the RX UE is to apply. For example, a signaling in the SCI, like the 1^{st} stage SCI or the 2^{nd} stage SCI, may cause the RX UE to select from the plurality of configured or preconfigured ON durations the one indicated for the transmission to be received from the TX UE.

For example, the RX UE may receive a DRX configuration defining the DRX cycle and the active time. The RX UE may receive the DRX configuration from one or more of the following:
a further UE performing the transmission,
a further UE not performing the transmission, e.g., a group leader UE of a group of UEs to which the UE belongs,
a relay node,
an RSU or IoT device,
an access point, like a base station, of the wireless communication system.

For example, the TX UE may configure one or more of the RX UEs to operate in the Discontinuous Reception, DRX, mode, and select or determine a DRX configuration for configuring a RX UE dependent on one or more of the above criteria.

In accordance with other embodiments, the active times may be controlled dynamically, for example they may be based on a previous transmission so that, for example, as explained above with reference to FIG. 6 and FIG. 7, any received packet may extend the ON duration, like the inactivity timer, so that the TX UE may send another packet. In other words, in accordance with such embodiments, an initially configured or preconfigured ON duration 252, for example by the DRX configuration information, may be extended responsive to the receiving of a transmission or a data packet, thereby creating the extended ON duration 262 which replaces the initially configured ON duration 252 for the DRX operation. For example, the actual lengths in time of the ON duration 252 for a DRX cycle may be extended for each following DRX cycle, i.e., instead of the periodic initial ON duration 252 following the receipt of a packet, the extended ON duration 262 is employed. In accordance with further embodiments, the extension may be revoked once the TX UE indicated an end of the transmission, i.e., following the receipt of a termination signaling 260 as explained above with reference to FIG. 6 and FIG. 7, the DRX cycle may stop using the extended ON duration 262 and go back to the initially configured ON duration 252, also referred to as the default ON duration.

In accordance with the just described embodiments, configured or preconfigured active times are used at the RX UE for determining the ON duration or the extended ON duration during a DRX cycle. In accordance with other embodiments, rather than defining a certain time period during which resources are to be monitored, a certain property of a SL transmission may be employed, namely the resources indicated or reserved for a SL transmission and possible future transmissions. Embodiments make use of this property to allow for a reduction of the power consumption by only monitoring those resources which are actually indicated or reserved for a sidelink transmission. The parameters used to indicate such future resources may be time and frequency resource assignment parameters. Such parameters may be defined using SCI format 1-a, 1^{st} stage SCI, which indicates the resources reserved within the next 32 time slots, for example, using the above mentioned TRIV format and the above mentioned FRIV format, respectively, or any of the formats mentioned above for signaling the reserved resources. The information about the reserved resources may be included in an assistance information message, AIM, which may be part of the SCI message, 1^{st} and/or 2^{nd} stage SCI, or may be separate from the SCI message, e.g., transmitted within the data or PSSCH.

Based on the information about the actual resources to be used for further transmissions by a TX UE, the RX UE, in addition to monitoring the resources during the ON duration, may further monitor those resources indicated by the TX UE for the one or more transmissions. Thus, limiting the additional monitoring of resources beyond the resources of the ON duration only to those resources indicated for a transmission allows for improving the power saving properties of the RX UE.

In accordance with embodiments, the power saving related to monitoring only the indicated resources may be achieved either by extending an ON duration based on the future resource reservations, or by listening only to the resources indicated for the future transmissions. In the first case, no fixed extension of the ON duration occurs, but the extension is only until the last resource signaled by the TX UE, so that the RX UE may stop monitoring other resources following the last indicated resource without the need of receiving an end of transmission signaling. This improves the power saving as only the resources following the ON duration are monitored where a transmission occurs, while transmission-free resources between the ON duration and the extended time do not need to be monitored, so that during such times the UE may go into the sleep mode or inactive mode.

FIG. 8 illustrates embodiments for the power saving by monitoring only indicated resources, wherein FIG. 8(a) illustrates an embodiment of extending an ON duration based on the future resource reservations, and FIG. 8(b) illustrates an embodiment of active time slots that are monitored based on the future resource reservations.

FIG. 8 illustrates the DRX cycle 250 of a RX UE. The DRX cycle 250 includes the periodic ON durations 252 which, in accordance with embodiments, may be extended dependent on the future resources that are reserved for a transmission by a TX UE. In the embodiment of FIG. 8, it is assumed that, as is indicated in the center of the figure, during the ON duration 252, an initial transmission is received from a TX UE at a time slot \textcircled{1}. The initial transmission is associated with control information also indicating the resources reserved for further transmissions of the TX UE sending the initial transmission. Such further transmissions may be retransmissions at time slots \textcircled{2} and \textcircled{3} of the initial transmission or, in accordance with other embodiments, may also include other initial transmissions of the TX UE. In the embodiment depicted in FIG. 8(a), the sending of two retransmissions is assumed, and the initial transmission at time slot \textcircled{1} indicates to the RX UE, using, for example, the assistance information, that the retransmissions occur at time slots \textcircled{2} and \textcircled{3}. The RX UE recognizes that the first retransmission at time slot \textcircled{2} is still within the ON duration 252, however, the second retransmission at time slot \textcircled{3} is outside the ON duration 252, and the RX UE extends the ON duration 252 by extending the activity time until the time slot \textcircled{3} where the last retransmission occurs, thereby creating the extended ON duration 262 dependent on the actual resources to be monitored. Thus, in accordance with the embodiment of FIG. 8(a), an incoming packet, like the initial transmission at time slot \textcircled{1}, during the active time or ON duration 252, causes an extension of the ON duration 252 by a time duration that depends on the indicated future reservations of time slots for the further transmissions, in the embodiment depicted by two time slots. Thus, in the embodiment of FIG. 8(a), the one further transmission at time slot \textcircled{3} outside the default ON duration 252 is signaled by the TX UE so that the RX UE extends its active time until the end of the reserved packet at time slot \textcircled{3}.

FIG. 8(b) illustrates an embodiment in accordance with which the RX UE listens only to those additional resources that lay outside the ON duration or default ON duration 252 which are indicated by the TX UE. The situation in FIG. 8(b) is similar to the one of FIG. 8(a) except that the RX UE only monitors the time slot \textcircled{3} indicated for the second retransmission outside the default ON duration 252, however, the two time slots between the end of the default ON duration 252 and the extended active time slot \textcircled{3} are not monitored by the RX UE.

Thus, while in accordance with FIG. 8(a), power saving properties of the RX UE are enhanced because the actual extension of the default ON duration is only until the last reserved resource for a transmission, like time slot \textcircled{3}, in FIG. 8(b), the power saving properties may be even further enhanced by not listening or by not monitoring the time slots between the default ON duration and the actual retransmission in time slot \textcircled{3}. Thus, to save power at the RX UE, it is ensured that the RX UE receives the transmission or transport block that is in the ON duration 252, but once the ON duration 252 is over, the RX UE only listens to those time slots that are indicated, for example by the TRIV format, otherwise the RX UE enters into the inactive or sleep mode between the indicated resources, thereby increasing the power saving capabilities.

In accordance with further embodiments, as mentioned above, the transmissions of a TX UE to an RX UE over the sidelink may include an initial transmission and retransmissions of the initial transmission as illustrated in FIG. 8. In accordance with further embodiments, when sending an initial transmission and retransmissions, after receiving the initial transmission within the ON duration 252, the RX UE may go into the sleep mode or inactive mode once the transmission was received successfully, i.e., the RX UE stops listening to future retransmissions of the transport block since the transmission was already successfully decoded. Thus, when considering FIG. 8, in case the initial transmission at time slot \textcircled{1} is successfully received at the RX UE, the RX UE may enter into the sleep or inactive mode following time slot \textcircled{1} as there is no need for further monitoring time slots \textcircled{2} and \textcircled{3}. In accordance with embodiments, the entering into the inactive/sleep mode may be deferred for one or more time slots following the initial, successfully received transmission in case the TX UE transmission is a HARQ-enable transmission, so that the RX UE, responsive to the successful initial transmission at time slot \textcircled{1}, sends the acknowledgement, ACK, or a sidelink assistance information, AIM, and then enters into the sleep mode. The same process may be applied in case the initial transmission is not successfully received, but when the first retransmission received at time slot \textcircled{2} is successfully decoded.

In accordance with further embodiments, the TX UE may perform periodic transmissions as defined in Rel-16 so that resources may be reserved for a further or second transmission or transport block. For example, using the above formats, like the TRIV parameter, may be used for indicating the resources for a further transmission. In such a case, the control information may include, in addition to the signaling of the actual resources that are reserved, as a further parameter, included, for example, in the SCI format 1-a, the so-called resource reservation period during which the same resources may be used for a further transmission following the indicated reservation period. In accordance with such embodiments, it may be that the TX UE needs to change the resources to be used for the transmission of the second or further transport block, and in such a situation, the TX UE may send a reservation period having a certain duration indicated, like a duration of zero which, in turn, informs the RX UE that no further transmissions are to be received or expected from the TX UE so that it may stop monitoring the resources for the mentioned transmissions and may enter into the sleep or inactive mode.

In accordance with further embodiments, the RX UE monitoring the time slots indicating the reserved resources, like the time slots following the ON duration or the actual time lot of the retransmission, like time slot \textcircled{3} in FIG. 8(b), may not receive a transmission or retransmission at that time slot. In such a situation, in accordance with embodiments, when not receiving the transmission or retransmission at the reserved resource \textcircled{3} outside the ON duration 252, the RX UE may stay active for a short period of time, for example by starting the inactivity timer following the time slot \textcircled{3} in which it was expecting the transmission. The missing of a retransmission at time slot \textcircled{3} may be due to a re-evaluation of the resources to be used by the TX UE, so that an initially signaled resource \textcircled{3} may be judged by the TX UE, for certain reasons, not to be usable for the transmission anymore. The UE, when staying active for a short period following the indicated resource \textcircled{3}, may detect the missing retransmission on an reevaluated resource selected by the TX UE. The retransmission may also not be received in case the retransmission is not decodable at the RX UE.

In accordance with other embodiments, the RX UE may stay active for a reception of n retransmissions, with n being smaller than or equal to a signaled or preconfigured maximum number of retransmissions. In accordance with other embodiments, the RX UE may go directly into the sleep or inactive mode and only wake up during the next ON duration. In accordance with yet other embodiments, the RX UE may send assistance information, like an AIM, to the TX UE including time and or frequency information where the RX UE is active any may receive a retransmission, or assistance information, like an AIM, to the TX UE including information about one or more ON durations of the RX UE.

### Extension/Restriction of Active Times by the RX UE

In accordance with embodiments of a fourth aspect of the present invention, the power saving properties of an RX UE communicating with other UEs over the sidelink may be further enhanced by determining whether a certain transmission of a TX UE is to be actually processed at the RX UE or not.

For example, in case a transmission received at the RX UE is judged to be of a certain type or has certain properties or meets certain criteria, the RX UE, for saving power, may only monitor for messages or transmissions that are in line with the requirements of a transmission to be processed by the RX UE while other transmissions or messages may be discarded. For example, the UE may decide to decode a transmission or to skip decoding a transmission responsive to one or more criteria. This reduces the power consumption because the necessary decoding of certain messages or transmissions is not carried out.

For example, whether a transmission is of interest to the RX UE may be determined on the basis of the destination ID, for example whether the transmission is a unicast transmission or a groupcast transmission, and/or dependent on a priority associated with the transmission, and/or whether a Hybrid Automatic Repeat Request, HARQ, indicator is associated with the transmission, and/or a cast type associated with the transmission, like a unicast transmission or a groupcast transmission or a broadcast transmission.

For example, the destination ID and the priority may be indicated in the SCI associated with the transmission and received in the monitored control channel during the ON duration. For example, when considering a priority of the application, a field in the 1^{st} stage SCI that is transmitted on the PSCCH may be evaluated. Evaluating the priority field in the 1^{st} stage SCI allows the RX UE to skip the PSSCH decoding in case the priority indicated is not at a certain level. For example, a power saving RX UE may only monitor for transmissions or messages above a certain priority while discarding or not decoding the PSSCH messages or transmissions with a lower priority.

When considering the destination, the RX UE may evaluate the destination field included in the 2^{nd} stage SCI that is transmitted on the PSSCH. For example, based on the indicated destination ID the RX UE may determine if a certain transmission is actually addressed to the Rx ID and needs to be decoded. Further, the RX UE may check whether the transmission is for a group or is a unicast transmission, for example dependent on a group ID and a unicast ID indicated in the destination field. For example, the RX UE may decide that unicast transmissions are to be decoded while groupcast transmissions may not be decoded.

In case a HARQ indicator associated with the transmission indicates that the transmitter requests a feedback for the transmission, the RX UE decodes the transmission and sends the feedback. Otherwise, i.e., in case the HARQ indicator indicates that the transmitter requests no feedback, the UE may skip the decoding to preserve power. In a further embodiment, the UE may even skip decoding in case a feedback is requested. This may for example be useful in a groupcast communication when a power saving group member is skipping low priority messages. However, when no feedback is sent the transmitter, which expects a feedback from all group members, the transmitter retransmits the message. In this case, to avoid said behavior, an ACK can be sent even though the message was not successfully decoded, thereby avoiding unnecessary retransmissions.

In accordance with other embodiments, the RX UE, may skip certain cast types. This may be configured by the TX UE or by the base station or may be preconfigured on the resource pool. The RX UE checks the cast type in a SCI, e.g., in a 1^{st} stage SCI or in a 2^{nd} stage SCI, and skips further decoding of the PSSCH if the transmission is of the certain cast type.

In accordance with further embodiments, the RX UE, may skip a further PSSCH decoding when a 2^{nd} stage SCI indicates a source ID different from a UE's list of interested communication partners. For example, the RX UE checks a source ID field in a 2^{nd} stage SCI on the physical sidelink shared channel, PSSCH, and skips further decoding of the PSSCH if the source ID field indicates that the transmission is not from a transmitter the RX UE is intending to receive communications from or is not on a list of source IDs to decode.

Further embodiments address the situation in which the RX UE, on the basis of the information from the 1^{st} stage SCI, decides that the second stage SCI on the PSSCH is to be decoded, however, the decoding fails. In such a situation or scenario, in case the priority indicated in the 1^{st} stage SCI is a high priority, i.e., is at a certain priority level, the RX UE may stay active for a certain time, for example by triggering the inactivity timer, so as to receive a retransmission of the packet. The RX UE may stay active for a certain time by extending the active time or, alternatively, by checking the reservation field in the 1^{st} stage SCI indicating where and when a retransmission is to be expected, so that the UE either stays active until the resource indicated in the reservation field (FIG. 8(a)), or becomes active again when the resource at which the retransmission occurs is reached (FIG. 8(b)).

In accordance with other embodiments, the RX UE, for example due to the indication of the reserved resources, is aware that a transmission at the location where the decoding failed was actually previously reserved for a transmission from the TX UE to the RX UE. In case the decoding failed, it is likely that a collision or a pre-emption of a transmission intended for the RX UE occurred. Also in this case, the active time during which the RX UE monitors the resources following the ON duration may be extended to detect and receive, in case of a collision, the next or, in case of pre-emption, an alternative transmission. This may also be applied in case the reserved resource did not contain the expected transmission at all, i.e., the decoding failed because there was no transmission.

### Actions by TX UE Based on HARQ Feedback

In accordance with embodiments of a fifth aspect of the present invention, the TX UE communicating with other UEs over the sidelink may send one or more transmissions or data packets during the ON duration of the RX UE and request a feedback, for example the TX UE may send HARQ-enabled transmissions. In case the RX UE does not report the required HARQ feedback for any of the packets or transmissions received, the TX UE may assume that the RX UE potentially did not receive the transmissions or packets or that this was due to another issue, for example the half-duplex issue. In such a scenario, the TX UE may assume that the RX UE missed the transmission or packet and, hence, did not prolong its active time. In other words, the TX UE assumes that the default ON duration of the DRX cycle applies so that the TX UE does not consider an immediate retransmission but waits until the next ON duration of the DRX cycle of the RX UE. In other words, the TX UE may hold back the HARQ enabled transmission, and the holding back may comprise one of more of the following:
There is no further retransmissions until the next ON duration.
There is no further retransmission for a current transport block, TB.
Rather than waiting until the next ON duration, the retransmissions for this TB is stopped right away.
Restarting a retransmission counter during the next ON duration.
Using an initial redundancy version, RV.
For example, in case the initial transmission was missed, the UE has no copy of the initial RV. However, the code is designed in a way that the decoding performance suffers when a UE is missing the initial RV. So the initial RV is send again as it has the best performance to be successfully decoded on its own.
reduce a number of retransmissions dependent on an amount of ON durations experienced.

In accordance with other embodiments, the TX UE may assume that the RX UE extended the default ON duration, for example by activating the inactivity timer, for example because it is assumed that the RX UE is likely to receive transmissions from two or more other transmitters over the sidelink. Also, the TX UE may assume that the RX UE did not respond because of the half-duplex issue. In either case, despite the fact that the default ON duration time has passed, the TX UE, on the basis of these assumptions, may retransmit the same transmission or packet for a configured or preconfigured number of times because of the extended ON duration period which is assumed to be triggered by the RX UE. In case the RX UE still does not respond to these retransmissions, the TX UE may hold the packet or transmission back until the next default ON duration.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IOT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 600. The units or modules as well as the steps of the methods performed by these units may execute on one or more computer systems 600.

The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

1. A device comprising:
a processor circuit and a memory circuit, wherein the memory is arranged to store instructions for the processor circuit,
wherein the processor circuit is arranged to receive at least one transmission from at least one second device over a sidelink,
wherein the processor circuit is arranged to operate in a Discontinuous Reception mode,
wherein the device is arranged to enter an inactive mode or sleep mode if a criterion is met.

2. The device of claim 1, wherein the criterion is selected from the group comprising reception of an end of transmission signaling, all transmissions announced from the at least one second device are received, successful reception of the at least one transmission, wherein the at least one transmission comprises resources reserved in the future for retransmissions of the at least one transmission there is no ongoing transmission from another one of the at least one second device, there is no ongoing transmission from a group leader device or a device with a certain ID, there is no ongoing transmission from a base station or relay node, a content of a received transmission, a number of times a certain transmission is received, a battery status of the UE is below a configured or pre-configured threshold, the device is moving in a certain geo-location, the device is moving or is not moving.

3. The device of claim 1, further comprising an inactivity timer,
wherein inactivity timer is arranged to specify a duration,
wherein the device is in an active state during the duration,
wherein the processor circuit is arranged to monitor at least a control channel so as to detect the at least one transmission,
wherein processor circuit is arranged is to start the inactivity timer response to receiving the at least one transmission by at least one third device.

4. The device of claim 3
wherein the processor circuit is arranged is to extend the duration in response to receiving a at least one second transmission from the least one third device and/or a transmission by at least one fourth device during the duration or by a signal from a group leader device or by a signal from a base station or relay node or road side unit,
wherein the processor circuit is arranged is to enter the inactive mode or sleep mode before reaching an end of the extended duration, if the criterion is met.

5. The device of claim 2,
wherein the device is arranged is to enter the inactive mode or sleep mode in response responsive to an end of transmission signaling,
wherein the processor circuit is arranged is to receive the end of transmission signaling from at least one of at least one third device transmitting the transmission that ended, at least one third device not transmitting the transmission that ended, a relay node, a road side unit, an access point.

6. The device of claim 5, wherein an end of transmission signaling by the at least one third device is indicated by at least one of a signaling of the end of the transmission by the at least one third device using a Discontinuous Reception command Medium Access Control or a or a MAC or a Control Element, a signaling of a number of resources reserved for the at least one transmission by the at least one third device, a sidelink control information, an assistance information message.

7. A device comprising:
a processor circuit and a memory circuit, wherein the memory is arranged to store instructions for the processor circuit,
wherein the processor circuit is arranged is to transmit at least one transmissions to at least one second device over a sidelink
wherein the at least one second device is operating in a Discontinuous Reception mode,
wherein the processor circuit is arranged is to indicate to the at least one second device at least one end of transmissions so as to enable the at least one second device to enter an inactive mode or sleep mode.

8. The device of claim 7, wherein the processor circuit is arranged is to indicate an end of the at least one transmissions to at least one second device by selecting from the group consisting of a signaling of the end of one of the at least one transmissions to the at least one second device, a signaling of a number of resources reserved for one the at least one transmissions to the at least one second device, a sidelink control information, an assistance information message, a buffer status report.

9. A device comprising:
a processor circuit and a memory circuit, wherein the memory is arranged to store instructions for the processor circuit,
wherein the processor circuit is arranged is to transmit a plurality of transmissions to at least one second device over a sidelink,
wherein the at least one second device is operating in a Discontinuous Reception mode, each of the plurality of transmissions comprising at least an initial transmission,
wherein the processor circuit is arranged is to transmit the plurality of transmissions to the at least one second device such that more than at least one of the plurality of transmissions occur within an ON duration of the Discontinuous Reception cycle of the at least one second device.

10. The device of claim 9, wherein at least one of the plurality of transmissions comprises at least one second transmission following an initial transmission.

11. The device of claim 9, wherein the plurality of transmissions are transmissions associated with a criterion.

12. The device of claim 11, wherein the criterion are selected from the group consisting of a priority reaching or exceeding a threshold, a quality of service requirement reaching or exceeding a threshold, a packet quota, a number of transmissions, the content of at least one message.

13. A device comprising:
a processor circuit and a memory circuit, wherein the memory is arranged to store instructions for the processor circuit,
wherein the processor circuit is arranged is to receive a transmission from at least one second device over a sidelink,
wherein the processor circuit is arranged is to operate in a Discontinuous Reception mode,
wherein the device is arranged is to be active during a time,
wherein the time depends on at least one criteria.

14. The device of claim 13, wherein the at least one criteria comprises at least one of: at least one characteristics of a packet of a transmission, a logical channel used for a transmission, a logical channel group used for a transmission, a quality of service flow, a quality of service requirement associated with a transmission, a geolocation or zone, a channel busy ratio, a type of device, at least one resources to be used by an initial transmission and/or at least one second transmission, a current battery status of the device.

15. The device of claim 13,
wherein the processor circuit is arranged is to receive a Discontinuous Reception configuration,
wherein the Discontinuous Reception configuration defines a Discontinuous Reception cycle and an active time,
wherein the device receives the Discontinuous Reception configuration from at least one of the at least one second device performing the transmission, at least one third device not performing the transmission, a relay node, a road side unit or an IoT device, an access point, a base station.

16. The device of claim 15, wherein the active time is configured or pre-configured or is dynamic.

17. The device of claim 16,
wherein the device is configured with a plurality of ON durations for the Discontinuous Reception cycle, and
wherein the processor circuit is arranged is to determine an ON duration based on the at least one criteria.

18. The device of claim 16,
wherein the processor circuit is arranged with at least one default ON durations for the Discontinuous Reception cycle, and
wherein the processor circuit is arranged extend a default ON duration to an extended ON duration based on a previous transmission.

19. The device of claim 18, wherein the processor circuit is arranged is to revoke the extended ON duration and return to the default ON duration in response to an end of the transmission that caused the extended ON duration.

20. The device of claim 13,
wherein a transmission comprises an initial transmission and at least one second transmission following the initial transmission,
wherein, the processor circuit is arranged to extend the active time to include at least the indicated one resources in response to an indication of at least one resources reserved for use by the at least one second transmission.

21. The device of claim 20, wherein the processor circuit is arranged to extend the active time by extending an ON duration for the Discontinuous Reception cycle until the indicated reserved resources, and/or adding to an ON duration for the Discontinuous Reception cycle only the indicated reserved resources monitored during the active time.

22. The device of claim 21, wherein the processor circuit is arranged is to enter the inactive or sleep mode between the ON duration and the indicated reserved resources.

23. The device of claim 21,
wherein the at least on second transmission are retransmissions of the initial transmission, and
wherein, the processor circuit is arranged is to enter the inactive or sleep mode after sending an acknowledgement or a sidelink assistance information in response to successfully receiving the initial transmission within the ON duration.

24. The device of claim 21,
wherein the at least one second transmission are retransmissions of the initial transmission,
wherein, in response to not receiving a retransmission at a reserved resource outside the ON duration, the processor circuit is arranged is to stay active for a period of time, or stay active for reception of n retransmissions, or enter the inactive or sleep mode and wake up only during the next ON duration of the Discontinuous Reception cycle or send assistance information, or send assistance information to the transmitter with information about an additional ON duration,
wherein n≤a signaled or is a preconfigured maximum number of retransmissions.

25. The device of claim 20,
wherein the processor circuit is arranged is to receive a resource reservation period indicating that the reserved resources are to be used for a third transmission during a period following the reservation period,
wherein the processor circuit is arranged is to extend the active time to include the indicated at least one resources during a period following the reservation period in response to an indication of the resource reservation period.

26. The device of claim 25, wherein the processor circuit is arranged is to enter the inactive or sleep mode and wake up only during the next ON duration of the Discontinuous Reception cycle in response to a resource reservation period having a certain duration.

27. The device of claim 20, wherein the one resources to be used by the at least one further transmission are indicated in a control message.

28. The device of claim 27, wherein the SCI indicates the resources reserved within a number of future time slots using, a time resource indicator value, format or a frequency resource indicator value.

29. A user device comprising:
a processor circuit and a memory circuit, wherein the memory is arranged to store instructions for the processor circuit,
wherein the processor circuit is arranged to communicate with at least one second device over a sidelink,
wherein the processor circuit is arranged to configure the at least one second device to operate in a Discontinuous Reception mode,
wherein the processor circuit is arranged to determine a Discontinuous Reception configuration for the at least one second device based on at least one criteria.

30. The device of claim 29, wherein the at least one criteria are selected from the group consisting of at least one characteristics of a packet of a transmission, a logical channel used for a transmission, a logical channel group used for a transmission, a quality of service flow, a quality of service requirement, a geolocation or zone, the type of the at least one second device the other Us, at least one resources to be used by an initial transmission and/or at least one second transmission, a current battery status of the device.

31. A user device comprising:
a processor circuit and a memory circuit, wherein the memory is arranged to store instructions for the processor circuit,
wherein the processor circuit is arranged to receive a transmission from at least one second device over a sidelink,
wherein the processor circuit is arranged to operate in a Discontinuous Reception mode,
wherein the processor circuit is arranged to be active during an active time during a Discontinuous Reception cycle,
wherein the processor circuit is arranged to decode or skip decoding a transmission in response to at least one criteria.

32. The device of claim 31, wherein the at least one criteria comprise a priority and/or a destination and/or a Hybrid Automatic Repeat Request indicator associated with the transmission and/or a cast type associated with the transmission.

33. The device of claim 32, wherein, the processor circuit is arranged to decode the transmission and send the feedback when the Hybrid Automatic Repeat Request indicates that the transmitter requests a feedback for the transmission.

34. The device of claim 32,
wherein the processor circuit is arranged to check a priority field in a 1^{st} stage sidelink control information on a physical sidelink control channel
wherein the processor circuit is arranged to skip decoding of an associated physical sidelink shared channel if the priority field indicates a priority that is below a threshold.

35. The device of claim 34,
wherein the processor circuit is arranged to check a destination field in a 2^{nd} stage sidelink control information on a physical sidelink shared channel,
wherein the processor circuit is arranged to skip further decoding of the physical sidelink shared channel if the destination field indicates that the transmission is not addressed to the device or to a plurality of devices,
wherein the plurality of devices comprise the device.

36. The device of claim 34,
wherein the processor circuit is arranged to check the cast type in a sidelink control information,
wherein the processor circuit is arranged to skip further decoding of the physical sidelink shared channel if the transmission is of a certain cast type.

37. The device of claim 34,
wherein the processor circuit is arranged to check a source ID field in a 2^{nd} stage sidelink control information on a physical sidelink shared channel,
wherein the processor circuit is arranged to skip further decoding of the physical sidelink shared channel if the source ID field indicates that the transmission is not from a transmitter the device expects to receive communications from or is not on a list of source IDs to decode.

38. The device of claim 35,
wherein the processor circuit is arranged to be active so as to receive a retransmission or to become active at resources indicated or reserved in the 1^{st} stage sidelink control information for the retransmission if decoding of a 2^{nd} stage sidelink control information fails and a priority field of a 1^{st} stage sidelink control information indicates a priority at or above the certain threshold,
wherein the processor circuit is arranged to extend an active time until the retransmission or another transmission is received if decoding of the 2^{nd} stage sidelink control information fails and the transmission is at a resource location previously reserved by a transmission for the UE, or
wherein the processor circuit is arranged to extend an active time until the retransmission or another transmission is received if a previously reserved resource does not contain an expected transmission.

39. A device comprising:
a processor circuit and a memory circuit, wherein the memory is arranged to store instructions for the processor circuit,
wherein the processor circuit is arranged to communicate with at least one second device over a sidelink
wherein the at least one second device operating in a Discontinuous Reception mode,
wherein the processor circuit WE is arranged to transmit at least one Hybrid Automatic Repeat Request enabled transmissions to the at least one second device during an ON duration of a Discontinuous Reception cycle of the at least one second device, and
wherein the processor circuit is arranged to hold back the Hybrid Automatic Repeat Request enabled transmission until the next ON duration of the at least one second device and to transmit the Hybrid Automatic Repeat Request enabled transmission during the next ON duration of the at least one second device.

40. The device of claim 39, wherein holding back the Hybrid Automatic Repeat Request enabled transmission comprises at least no second retransmission for a current transport block, no second retransmissions until the next ON duration, restarting a retransmission counter during the next ON duration, using an initial redundancy version, reduce a number of retransmissions based on an amount of ON durations experienced.

41. The device of claim 39,
wherein the processor circuit is arranged to retransmit the Hybrid Automatic Repeat Request enabled transmission for a certain number of times, although a default ON duration has passed, and, in response to not receiving a Hybrid Automatic Repeat Request feedback,
wherein the processor circuit is arranged to hold back the Hybrid Automatic Repeat Request enabled transmission until the next ON duration of the at least one second device and to transmit the Hybrid Automatic Repeat Request enabled transmission during the next ON duration of the at least one second device.

42. The device of claim 39
wherein the device operated in an out-of-coverage mode,
wherein the device is not connected to a first base station of a wireless communication system,
wherein the device is connected to a second base station of the wireless communication system,
wherein the device is not capable to provide a sidelink resource allocation configuration or assistance for the device,
wherein the device is connected to a third base station of the wireless communication system not supporting a sidelink service.

43. (canceled)

44. (canceled)

45. (canceled)

46. A method for operating a device comprising:
receiving a transmission from at least one second device over a sidelink;
operating in a Discontinuous Reception mode; and
entering an inactive mode or sleep mode if a criterion is met.

47. A method for operating a user device comprising:
transmitting at least one transmissions to at least one second device over a sidelink wherein the at least one second device is operating in a Discontinuous Reception mode; and
indicating to the at least one second device an end of the at least one transmissions so as to enable the at least one second device to enter an inactive mode or sleep mode.

48. A method for operating a device comprising:
transmitting a plurality of transmissions to at least one second device over a sidelink
wherein the at least one second device is operating in a Discontinuous Reception, mode,
wherein each of the plurality of transmissions comprise at least an initial transmission; and
wherein the plurality of transmissions are transmitted to the at least one second device such that more than at least one of the initial transmissions fall within an ON duration of the Discontinuous Reception cycle of the at least one second device.

49. A method for operating a device comprising:
receiving a transmission from at least one second device over a sidelink;
operating in a Discontinuous Reception mode; and
staying active during a active time,
wherein the active time depends on at least one criteria.

50. A method for operating a device comprising:
communicating with at least one second device over a sidelink; and
configuring at least one second device to operate in a Discontinuous Reception mode; and
determining a Discontinuous Reception configuration for at least on second device based on at least one criteria.

51. A method for operating a device comprising:
communicating with at least one second device over a sidelink;
operating in a Discontinuous Reception mode, wherein the device is active during an active time; and
decoding or skipping decoding a transmission in response to at least one criteria.

52. A method for operating a device comprising:
communicating with at least one second device over a sidelink;
operating in a Discontinuous Reception mode;
transmitting at least one Hybrid Automatic Repeat Request enabled transmissions to the at least one second device during an ON duration of a Discontinuous Reception cycle of the at least one second device; and
holding back the Hybrid Automatic Repeat Request enabled transmission until the next ON duration of the at least one second device and transmitting the Hybrid Automatic Repeat Request enabled transmission during the next ON duration of the at least one second device in response to not receiving a Hybrid Automatic Repeat Request feedback.

53. A computer program stored on a non-transitory medium, wherein the computer program when executed on a processor performs the method as claimed in claim 46.

54. A computer program stored on a non-transitory medium, wherein the computer program when executed on a processor performs the method as claimed in claim 47.

55. A computer program stored on a non-transitory medium, wherein the computer program when executed on a processor performs the method as claimed in claim 48.

56. A computer program stored on a non-transitory medium, wherein the computer program when executed on a processor performs the method as claimed in claim 49.

57. A computer program stored on a non-transitory medium, wherein the computer program when executed on a processor performs the method as claimed in claim 50.

58. A computer program stored on a non-transitory medium, wherein the computer program when executed on a processor performs the method as claimed in claim 51.

59. A computer program stored on a non-transitory medium, wherein the computer program when executed on a processor performs the method as claimed in claim 52.
